(19) United States
(12) Patent Application Publication
(10) Pub. No.: US 2025/0373593 A1
(43) Pub. Date: Dec. 4, 2025

(54) ROUTING DIGITAL MESSAGES VIA AUTHENTICATION NETWORKS

(71) Applicant: Entersekt International Limited, Cybercity (MU)

(72) Inventors: Benedicto Hernandez DOMINGUEZ, Fairfield, CA (US); Jari Sakari HEIKKINEN, Dubai (AE)

(21) Appl. No.: 19/221,373

(22) Filed: May 28, 2025

Related U.S. Application Data
(60) Provisional application No. 63/652,890, filed on May 29, 2024.

(51) Int. Cl. H04L 9/40

(52) U.S. Cl. CPC H04L 63/08

(57) ABSTRACT

A system and method for routing digital messages via authentication networks are provided. The method may include, at a first directory server, maintaining a routing data structure with routing information. The routing information may include first and second destination endpoint identifiers. The method may include updating a first source endpoint with configuration to transmit messages to a first destination endpoint and messages to a second destination endpoint, associated with respective endpoint identifiers. The method may include, in response to receiving a first message associated with a first destination endpoint identifier, routing the first message to a first destination endpoint and, in response to receiving a second message associated with a second destination endpoint identifier, routing the second message to a destination interface of a hosted system. The system may include a first directory server and a hosted system for performing the method.

### CROSS-REFERENCE TO RELATED APPLICATION

The application claims priority from U.S. provisional patent application No. 63/652,890 filed on 29 May 2024, the entirety of which is incorporated by reference herein.

### FIELD

This disclosure relates to authentication networks. More particularly, although not exclusively, the present disclosure relates to a system and method for routing digital messages via authentication networks.

### BACKGROUND

There are various examples today where collections of computing devices (termed “endpoints” herein) are connected to each other via different data communication networks. Such networks can be vast, including thousands of endpoints (or more), which may be distributed across large geographical areas. In some cases, some of the endpoints are connected to each other via multiple such networks. For example, in some cases a first endpoint may be connected to a second endpoint by a directory server of a first network and by a directory server of a second network. However, there are cases at present where certain networks are separate from the other networks such that endpoints on these separate networks cannot exchange data, such as messages, with endpoints on the other networks. Increasingly, however, it is becoming necessary for endpoints on the separate networks to communicate with endpoints on the other networks, and vice versa.

Considering the scale of these networks, and further considering that some or even all of the endpoints may be under the control of third party entities which are distinct from the entities maintaining the respective networks, configuring the endpoints and/or the networks for integration may be a technically challenging and time-consuming task.

There is accordingly scope for improvement.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the present disclosure there is provided a computer-implemented method conducted at a first directory server comprising: maintaining a routing data structure which includes a first set of routing information mapping a first destination endpoint identifier to a first destination endpoint and a second set of routing information mapping a second destination endpoint identifier to a destination interface of a hosted system; updating a first source endpoint with configuration to transmit messages associated with the first destination endpoint identifier and messages associated with the second destination endpoint identifier to the first directory server; in response to receiving, from the first source endpoint, a first message associated with the first destination endpoint identifier, routing the first message to the first destination endpoint; and, in response to receiving, from the first source endpoint, a second message associated with the second destination endpoint identifier, routing the second message to the destination interface of the hosted system.

Updating the first source endpoint with configuration may form part of a routine update process. The routine update process may form part of a preparation process of a security protocol. Updating the first source endpoint with configuration to transmit messages associated with the first destination endpoint identifier and messages associated with the second destination endpoint identifier to the first directory server may ensure that a normal configuration update process provides to the first source endpoint both first destination and second destination endpoint identifiers as targets for the first directory server. Updating the first source endpoint may be an update process providing, to the first source endpoint, both first destination and second destination endpoint identifiers as targets for the first directory server

Maintaining the routing data structure may include maintaining a directory server routing data structure and an endpoint routing data structure.

The directory server routing data structure may include the first set of routing information and the second set of routing information. The first set of routing information may include the first destination endpoint identifier and a first destination endpoint address. The second set of routing information may include the second destination endpoint identifier and a destination interface address which points to the destination interface of the hosted system.

The endpoint routing data structure may include a mapping of the first destination endpoint identifier and the second destination endpoint identifier to the first directory server.

Updating the first source endpoint with configuration to transmit messages associated with the first destination endpoint identifier and messages associated with the second destination endpoint identifier to the first directory server may include transmitting the endpoint routing data structure to the first source endpoint.

The method may include periodically updating the routing data structure. Periodically updating the routing data structure may include periodically updating one or both of the directory server routing data structure and the endpoint routing data structure. The method may include periodically updating the first source endpoint with configuration to transmit messages associated with the first destination endpoint identifier and messages associated with the second destination endpoint identifier to the first directory server.

The method may include, during an initialisation stage: receiving the second set of routing information from the hosted system; updating the routing data structure to include the second set of routing information in addition to the first set of routing information; and, updating the first source endpoint with configuration to transmit messages associated with the second destination endpoint identifier to the first directory server in addition to transmitting messages associated with the first destination endpoint identifier to the first directory server.

The hosted system may be configured to modify the second message to indicate a source interface of the hosted system as the source of the message and to forward the modified second message to a second directory server associated with the second destination endpoint. The method may include, in response to receiving, from the hosted system, a third message being a response to the second message and indicating the destination interface of the hosted system as the source of the message, routing the third message to the first source endpoint.

The first and second messages may be authentication request (AReq) messages of a security protocol. The third message may be an authentication response (ARes) message of the security protocol.

Receiving the second set of routing information from the hosted system may include receiving the second set of routing information in a preparation response message (PRes) of the security protocol. Updating the first source endpoint with configuration to transmit messages associated with the first destination endpoint identifier and messages associated with the second destination endpoint identifier to the first directory server may include transmitting a PRes message including the first destination endpoint identifier and the second destination endpoint identifier to the source endpoint.

In accordance with another aspect of the present disclosure there is provided a computer-implemented method conducted at a hosted system, the method comprising: receiving, at a destination interface of the hosted system, a second message from a first source endpoint via a first directory server; modifying the second message to indicate a source interface of the hosted system as the source of the message and forwarding the modified second message to a second directory server associated with the second destination endpoint; receiving, at the source interface of the hosted system, a third message being a response to the second message having been transmitted from the second destination endpoint via the second directory server; and, modifying the third message to indicate the destination interface of the hosted system as the source of the message and forwarding the modified third message to the first source endpoint via the first directory server.

The method may include transmitting a second set of routing information to the first directory server for updating a routing data structure to include the second set of routing information, wherein the second set of routing information is associated with the second destination endpoint and the destination interface of the hosted system.

Modifying the second message to indicate the source interface of the hosted system as the source of the message may include updating a source field of the message to replace an identifier of the first source endpoint with an identifier of the source interface of the hosted system. The identifiers of the first source endpoint and source interface may be addresses.

Forwarding the modified second message to the second directory server associated with the second destination endpoint may include forwarding the modified second message from the source interface of the hosted system.

Forwarding the modified second message from the source interface of the hosted system may include authenticating the source interface of the hosted system with the second directory server.

Modifying the third message to indicate the destination interface of the hosted system as the source of the message may include updating a source field of the message to replace an identifier of the second destination endpoint with an identifier of the destination interface of the hosted system.

Forwarding the modified third message to the first source endpoint via the first directory server may include forwarding the modified third message from the destination interface of the hosted system.

Forwarding the modified third message from the destination interface of the hosted system may include authenticating the destination interface of the hosted system with the first directory server.

In accordance with a further aspect of the disclosure there is provided a computer-implemented method conducted at a first source endpoint comprising: transmitting a set update request to a first directory server, the set update request being a message prompting the first directory server to send an updated list of routing information on a first authentication network; receiving, from the first directory server, a set update response including the updated list of routing information; and, storing the updated list of routing information in a local endpoint routing data structure, wherein the updated list includes routing information mapping a first destination endpoint identifier and a second destination endpoint identifier to the first directory server.

In accordance with a further aspect of the disclosure there is provided a system including a first source endpoint having a memory for storing computer-readable program code and a processor for executing the computer-readable program code, the system comprising: an endpoint set update request transmitting component for transmitting a set update request to a first directory server, the set update request being a message prompting the first directory server to send an updated list of routing information on a first authentication network; an endpoint routing set receiving component for receiving, from the first directory server, a set update response including the updated list of routing information; and, an endpoint routing set storing component for storing the updated list of routing information in a local endpoint routing data structure, wherein the updated list includes routing information mapping a first destination endpoint identifier and a second destination endpoint identifier to the first directory server.

The system may include a first directory server, including: a routing set maintaining component for maintaining a routing data structure which includes a first set of routing information mapping a first destination endpoint identifier to a first destination endpoint and a second set of routing information mapping a second destination endpoint identifier to a destination interface of a hosted system; an endpoint updating component for updating a first source endpoint with configuration to transmit messages associated with the first destination endpoint identifier and messages associated with the second destination endpoint identifier to the first directory server; a message routing component for, in response to receiving, from the first source endpoint, a first message associated with the first destination endpoint identifier, routing the first message to the first destination endpoint and for, in response to receiving, from the first source endpoint, a second message associated with the second destination endpoint identifier, routing the second message to the destination interface of the hosted system.

The system may include a hosted system, including: a second message receiving component for receiving, at a destination interface of the hosted system, a second message from a first source endpoint via a first directory server; a message modifying and forwarding component for modifying the second message to indicate a source interface of the hosted system as the source of the message and forwarding the modified second message to a second directory server associated with the second destination endpoint; a third message receiving component for receiving, at the source interface of the hosted system, a third message being a response to the second message having been transmitted from the second destination endpoint via the second directory server; and, the message modifying and forwarding component being further for modifying the third message to indicate the destination interface of the hosted system as the source of the message and forwarding the modified third message to the first source endpoint via the first directory server.

In accordance with a further aspect of the disclosure there is provided a system including a first source endpoint comprising: a non-transitory computer-readable storage medium; and one or more processors coupled to the non-transitory computer-readable storage medium, wherein the non-transitory computer-readable storage medium comprises program instructions that, when executed on the one or more processors, cause the first source endpoint to perform operations comprising: transmitting a set update request to a first directory server, the set update request being a message prompting the first directory server to send an updated list of routing information on a first authentication network; receiving, from the first directory server, a set update response including the updated list of routing information; and, storing the updated list of routing information in a local endpoint routing data structure, wherein the updated list includes routing information mapping a first destination endpoint identifier and a second destination endpoint identifier to the first directory server.

In accordance with a further aspect of the disclosure there is provided a system including a first directory server comprising: a non-transitory computer-readable storage medium; and one or more processors coupled to the non-transitory computer-readable storage medium, wherein the non-transitory computer-readable storage medium comprises program instructions that, when executed on the one or more processors, cause the first directory server to perform operations comprising: maintaining a routing data structure which includes a first set of routing information mapping a first destination endpoint identifier to a first destination endpoint and a second set of routing information mapping a second destination endpoint identifier to a destination interface of a hosted system; updating a first source endpoint with configuration to transmit messages associated with the first destination endpoint identifier and messages associated with the second destination endpoint identifier to the first directory server; in response to receiving, from the first source endpoint, a first message associated with the first destination endpoint identifier, routing the first message to the first destination endpoint; and, in response to receiving, from the first source endpoint, a second message associated with the second destination endpoint identifier, routing the second message to the destination interface of the hosted system.

In accordance with a further aspect of the disclosure there is provided a system including a hosted system comprising: a non-transitory computer-readable storage medium; and one or more processors coupled to the non-transitory computer-readable storage medium, wherein the non-transitory computer-readable storage medium comprises program instructions that, when executed on the one or more processors, cause the hosted system to perform operations comprising: receiving, at a destination interface of the hosted system, a second message from a first source endpoint via a first directory server; modifying the second message to indicate a source interface of the hosted system as the source of the message and forwarding the modified second message to a second directory server associated with the second destination endpoint; receiving, at the source interface of the hosted system, a third message being a response to the second message having been transmitted from the second destination endpoint via the second directory server; and, modifying the third message to indicate the destination interface of the hosted system as the source of the message and forwarding the modified third message to the first source endpoint via the first directory server.

In accordance with a further aspect of the disclosure there is provided a computer program product comprising a computer-readable medium having stored computer-readable program code for performing, at a first directory server, the steps of: maintaining a routing data structure which includes a first set of routing information mapping a first destination endpoint identifier to a first destination endpoint and a second set of routing information mapping a second destination endpoint identifier to a destination interface of a hosted system; updating a first source endpoint with configuration to transmit messages associated with the first destination endpoint identifier and messages associated with the second destination endpoint identifier to the first directory server; in response to receiving, from the first source endpoint, a first message associated with the first destination endpoint identifier, routing the first message to the first destination endpoint; and, in response to receiving, from the first source endpoint, a second message associated with the second destination endpoint identifier, routing the second message to the destination interface of the hosted system.

In accordance with a further aspect of the disclosure there is provided a computer program product comprising a computer-readable medium having stored computer-readable program code for performing, at a hosted system, the steps of: receiving, at a destination interface of the hosted system, a second message from a first source endpoint via a first directory server; modifying the second message to indicate a source interface of the hosted system as the source of the message and forwarding the modified second message to a second directory server associated with the second destination endpoint; receiving, at the source interface of the hosted system, a third message being a response to the second message having been transmitted from the second destination endpoint via the second directory server; and, modifying the third message to indicate the destination interface of the hosted system as the source of the message and forwarding the modified third message to the first source endpoint via the first directory server.

In accordance with a further aspect of the disclosure there is provided a computer program product comprising a computer-readable medium having stored computer-readable program code for performing, at a first source endpoint, the steps of: transmitting a set update request to a first directory server, the set update request being a message prompting the first directory server to send an updated list of routing information on a first authentication network; receiving, from the first directory server, a set update response including the updated list of routing information; and, storing the updated list of routing information in a local endpoint routing data structure, wherein the updated list includes routing information mapping a first destination endpoint identifier and a second destination endpoint identifier to the first directory server.

Further features provide for the computer-readable medium to be a non-transitory computer-readable medium and for the computer-readable program code to be executable by a processing circuit.

Examples will now be described with reference to the accompanying drawings.

### BRIEF DESCRIPTION OF THE DRAWINGS

In the drawings:

FIG. 1A is a schematic diagram which illustrates an example system for routing digital messages via authentication networks according to aspects of the present disclosure;

FIG. 1B is a schematic diagram which illustrates an example directory server of a first authentication network according to aspects of the present disclosure;

FIG. 1C is a schematic diagram which illustrates an example directory server routing data structure according to aspects of the present disclosure;

FIG. 1D is a schematic diagram which illustrates an example endpoint routing data structure according to aspects of the present disclosure;

FIG. 2A is a swim-lane flow diagram which illustrates an example method for updating a set of routing information according to aspects of the present disclosure;

FIG. 2B is a continuation of the flow diagram of FIG. 2A;

FIG. 3A is a swim-lane flow diagram which illustrates an example method for routing digital messages via authentication networks according to aspects of the present disclosure;

FIG. 3B is a continuation of the flow diagram of FIG. 3A;

FIG. 4A is a schematic diagram which illustrates routing a first message via authentication networks according to aspects of the present disclosure;

FIG. 4B is a schematic diagram which illustrates routing a second message via authentication networks according to aspects of the present disclosure;

FIG. 5A is a block diagram which illustrates components of an example system for routing digital messages via authentication networks according to aspects of the present disclosure;

FIG. 5B is a block diagram which illustrates components of an example system for an endpoint the present disclosure; and,

FIG. 6 illustrates an example of a computing device in which various aspects of the disclosure may be implemented.

### DETAILED DESCRIPTION

Users expect online payments and transactions to be fast, seamless and safe, despite there being a large number of online merchants and credit card providers. These card providers may not be able to communicate with one another directly, to all online merchants, or to other banks. The distributed nature of the online payment process may limit users with credit cards from a specific issuer from using the online payment process of a particular merchant that they wish to purchase from, but who does not support the particular card provider.

A system and method for routing digital messages between separate networks that do not interface with one another, is disclosed. An embodiment of such digital message may include transaction authentication requests. In particular, the disclosure relates to routing digital messages via authentication networks.

In an exemplary scenario that an online merchant does not provide a communication system with a user's particular credit card provider, the merchant may route the payment information to a provided hosted system, which may include the required communication facilities and interfaces to facilitate such communication requests.

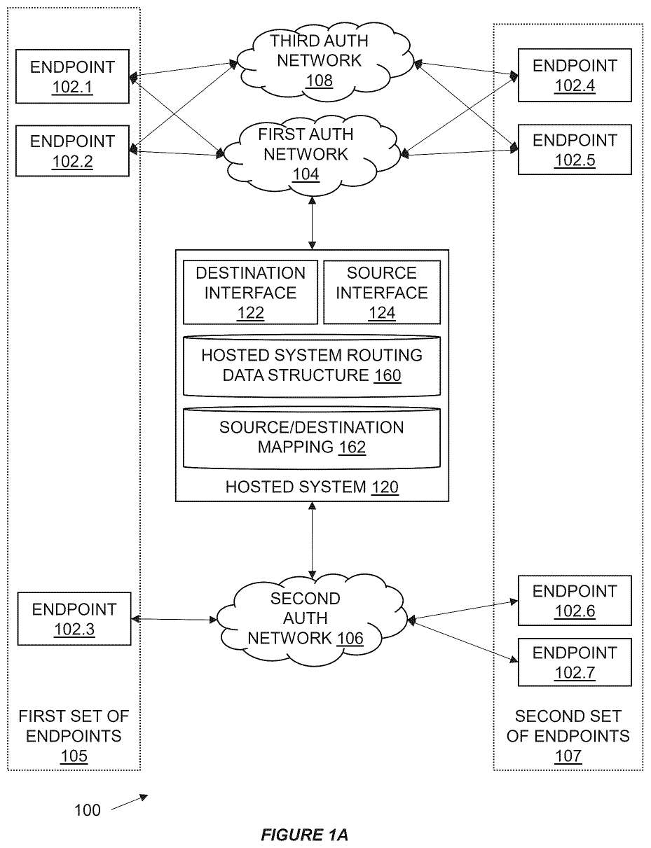

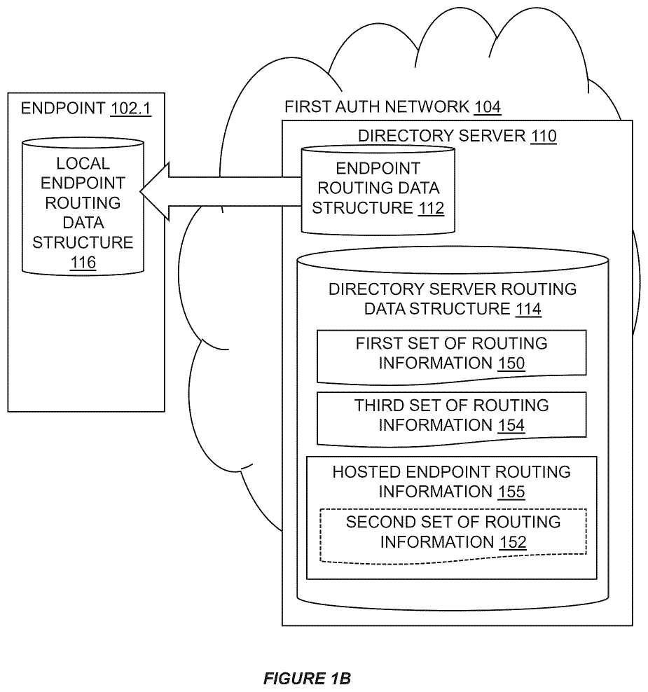

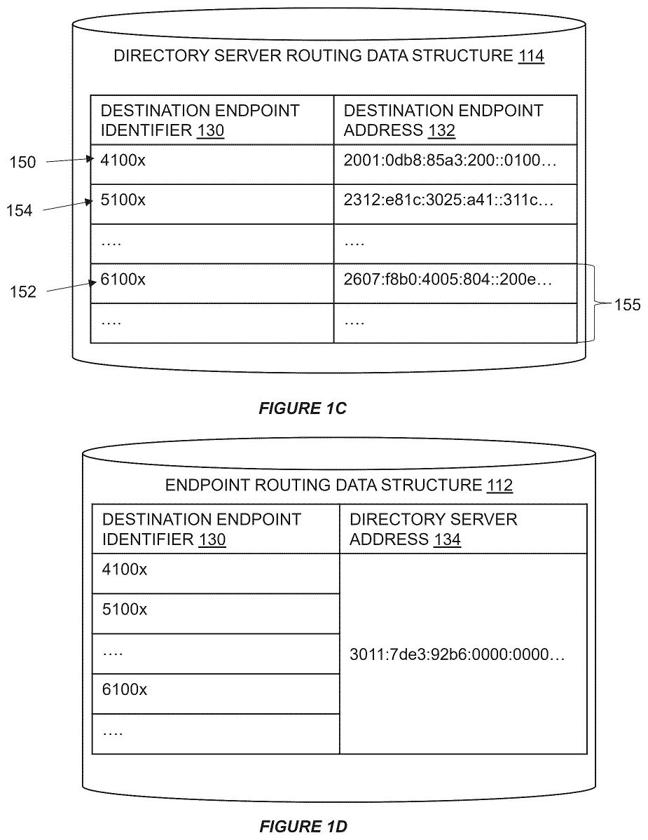

FIG. 1A is a schematic diagram which illustrates an exemplary system (100) for routing digital messages via authentication networks according to aspects of the present disclosure. The system may include a plurality of endpoints (102.1 to 102.7), a plurality of authentication networks (104, 106, 108) and a hosted system (120).

The endpoints and authentication networks may implement a security protocol. In some examples, different endpoints perform different roles in the security protocol. For example, a first set of endpoints (105) may perform a first role in the security protocol while a second set of endpoints (107) may perform a second role in the security protocol. The first role may be an authentication requesting role and the second role may be an authentication confirming/providing or declining role. In some examples, endpoints configured to perform the first role are termed “source endpoints” or “authentication requesting endpoints” while endpoints configured to perform the second role are termed “destination endpoints” or “authentication providing or declining endpoints”. In some examples, the security protocol is the three-domain secure (also termed “3-D Secure” or “3DS”) security protocol and the first set of endpoints are configured as 3DS servers while the second set of endpoints are configured as access control servers (ACSs).

Each endpoint may be in the form of or provided by a computing device. Each endpoint is configured to transmit and receive messages. Each endpoint may be configured to transmit and receive messages to one or more other endpoints via one or more of the authentication networks.

The messages may be authentication messages. In some examples, the messages may be request or response messages, such as authentication request (AReq) and authentication response (ARes) messages, or the like. Each endpoint may be associated with an address including information by way of which messages can be directed or routed towards that endpoint. In some examples, the endpoint addresses are internet protocol (IP) or equivalent addresses.

In some examples, each endpoint of the second set of endpoints is maintained by or on behalf of an entity identified by way of an entity identifier (which may also be termed an “endpoint identifier” or “destination endpoint identifier” herein). In some examples, the entity is an issuing financial institution, and the entity identifier is an issuer or bank identification number (IIN or BIN).

Each of the authentication networks may be private authentication networks. Each of the authentication networks may be under the control of a different entity. Endpoints may require permission from an entity operating an authentication network to transmit and receive messages via the authentication network. That is, endpoints may be required to be enrolled with the authentication network. Enrollment or permission may for example be managed by way of public key infrastructure (PKI), or the like. In the example of FIG. 1A, endpoints (102.1, 102.2, 102.4 and 102.5) are enrolled to transmit and/or receive messages via either of the first authentication network (104) and the third authentication network (108). Endpoints (102.3, 102.6 and 102.7) are enrolled to transmit and/or receive messages via the second authentication network (106).

In some examples, each authentication network includes or is provided by a directory server (DS) configured in accordance with the security protocol. Enrollment of endpoints onto or into an authentication network may require configuration at the endpoint. For example, the endpoint may be provided with or may be required to generate an endpoint keypair. The endpoint keypair may include an endpoint public key and a corresponding endpoint private key. The endpoint may enroll the endpoint public key with a relevant authentication network. Similarly, the endpoint may be required to store a network public key corresponding to a network private key of a network keypair. Such a key exchange may enable mutual authentication (such as mutual transport layer security (TLS)) between endpoints via the network and also allows the authentication network to restrict access to the network to enrolled endpoints only.

Each authentication network may maintain and/or have access to a directory server routing data structure usable by that authentication network to route messages to endpoints (such as destination endpoints) enrolled therewith. Each authentication network may further be configured to provide an endpoint routing data structure to endpoints (such as source endpoints) enrolled therewith for those endpoints to use in determining which messages to route via the authentication network (and not another authentication network). For example, a given authentication network (e.g., 108) may be able to route messages to a plurality of destination endpoints (102.4, 102.5), each of which is associated with a different destination endpoint identifier. The endpoint routing data structure may instruct a source endpoint (e.g., 102.1) that when the source endpoint needs to route a message associated with a destination endpoint identifier falling within the endpoint routing data structure received from that authentication network, such a message should be routed to that (in this example the third) authentication network.

Although only a handful of endpoints are illustrated in FIG. 1A, it should be appreciated that in a practical implementation there may be thousands up to millions of endpoints. Similarly, although only three authentication networks are illustrated, there may be more of these. There may be scenarios where it would be advantageous or desirable for an endpoint having configuration to transmit and/or receive messages via one authentication network to be able to transmit and/or receive messages to an endpoint with configuration to transmit and/or receive messages via another authentication network. In other words, in the example of FIG. 1A, it may be advantageous or desirable for a first endpoint (102.1) (having configuration to transmit and/or receive messages via a first and/or third authentication network (104, 108)) to be able to transmit and/or receive messages to a third endpoint (e.g., 102.6, having configuration to transmit and/or receive messages via a second authentication network (106)).

The hosted system of the present application may be provided for this purpose. The hosted system may be provided by, maintained by and/or under the control of an entity maintaining one of the authentication networks or a third-party entity providing hosted system services to one or more of the entities maintaining the authentication networks. The hosted system may provide or may be in the form of a network-network interface. The hosted system may bridge one authentication network to one or more other authentication networks. The hosted system may be termed “hosted” because it may rely on configuration at a participating (“hosting”) authentication network. The hosting authentication network thus “hosts” the hosted system.

The hosted system may be provided by a computing device. The hosted system may include a destination interface (122) and a source interface (124). The source interface may be configured to perform or emulate the first role in the security protocol. In some examples, the source interface is configured as or emulates a 3DS server. The source interface may be associated with a source interface address by which messages may be directed or routed to the source interface. The destination interface may be configured to perform or emulate the second role in the security protocol. In some examples, the destination interface may be configured as or emulates an ACS. The destination interface may be associated with a destination interface address by way of which messages may be directed or routed to the destination interface. The destination interface address may be different from the source interface address. In the example of FIG. 1A, the hosted system is hosted by the first authentication network and is configured to interface with the second authentication network. In should be appreciated that although the hosted system is illustrated as interfacing with only one authentication network, in a practical implementation the hosted system may interface with a plurality of authentication networks.

Referring now to FIG. 1B, the first authentication network (104) includes a directory server (110). The first authentication network maintains and/or has access to a routing data structure. In some examples, the routing data structure is a routing table. The routing data structure may include one or both of an endpoint routing data structure (112) and a directory server routing data structure (114). In some examples, the endpoint routing data structure and directory server routing data structure are discrete data structures (e.g. in the form of discrete routing tables). In other examples, the endpoint routing data structure and directory server routing data structure are different parts of the same data structure (e.g. the endpoint routing data structure may point to a subset of columns or rows in a table providing the directory server routing data structure). In other examples, the endpoint routing data structure is derived from (e.g. is an aggregation of) the directory server routing data structure.

The directory server routing data structure may include a set of routing information for each destination endpoint enrolled with (i.e., configured to communicate on) the first authentication network. The directory server routing data structure may for example include a first set of routing information (150) for a first destination endpoint (102.4) and a third set of routing information (154) for a third destination endpoint (102.5). The first set of routing information (150) may map a first destination endpoint identifier to a first destination endpoint. The third set of routing information (154) may map a third destination endpoint identifier to a third destination endpoint.

The directory server routing data structure may further include one or more sets of hosted endpoint routing information (155) for destination endpoints of other authentication networks accessible via the hosted system. The directory server may for example include a second set of routing information (152) which maps a second destination endpoint identifier to a destination interface of a hosted system.

Referring to FIG. 1C, the directory server data structure may map destination endpoint identifiers (130) to destination endpoint addresses (132). The destination endpoint addresses may include information usable in routing messages to the destination endpoint. In one example, the destination endpoint addresses are provided by way of internet protocol (IP) addresses. In the example of FIG. 1C, therefore, the first set of routing information (150) includes: a first destination endpoint identifier mapped to a first destination endpoint address. The third set of routing information (154) includes: a third destination endpoint identifier mapped to a third destination endpoint address. The second set of routing information (152) includes a second destination endpoint identifier mapped to a destination interface address which identifies the destination interface of the hosted system.

Referring now to FIG. 1D, the endpoint routing data structure may include destination endpoint identifiers (130) corresponding to destination endpoints enrolled with the first authentication network. The destination endpoint routing data structure may include a directory server address (134) usable by the source endpoints in addressing or routing messages to the directory server of the first authentication network.

The first authentication network is configured to provide the endpoint routing data structure to the source endpoints enrolled therewith for local storage in a local endpoint routing data structure (116).

Returning now to FIG. 1A, the hosted system may similarly maintain a hosted system routing data structure (160). The hosted system routing data structure may include a mapping of all destination endpoint identifiers to corresponding directory servers of authentication networks with which the hosted system is configured to interact. In the illustrated example, the hosted system routing data structure includes a mapping of the second destination endpoint identifier and a fourth endpoint identifier (corresponding to an entity maintaining a fourth destination endpoint (102.7)) to the directory server of the second authentication network (106). In this manner, the hosted system routing data structure corresponds to the endpoint routing data structure in that it maps a range of destination endpoint identifiers to the directory server of the second authentication network. The hosted system may be configured to provide a listing of all destination endpoint identifiers for all destination endpoints with which the hosted system is configured to interact (via the second authentication network) to the first authentication network for the first authentication network to include in the directory server routing data structure. However, in doing so, the hosted system replaces an address of the directory server of the second authentication network with an address of the destination interface of the hosted system.

The hosted system may further maintain a source/destination mapping (162) which may be configured to store, temporarily, source endpoint and destination endpoint addresses which may be extracted from messages and replaced with the source interface address and destination interface address of the hosted system.

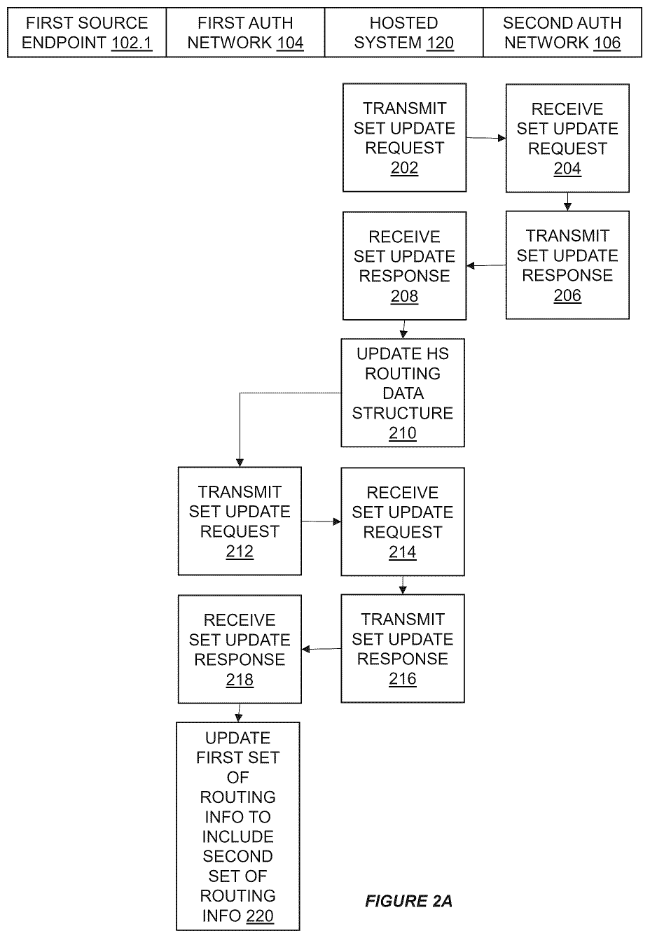

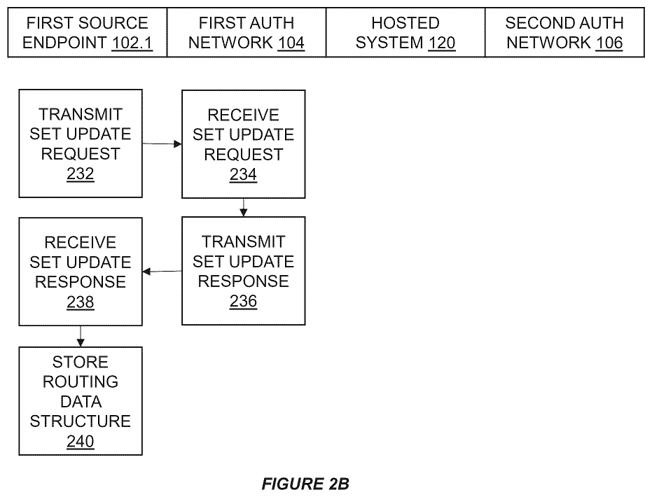

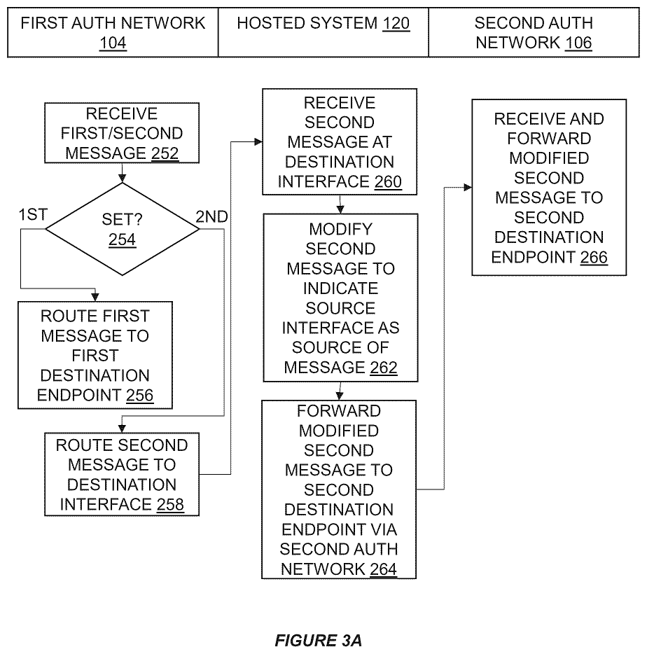

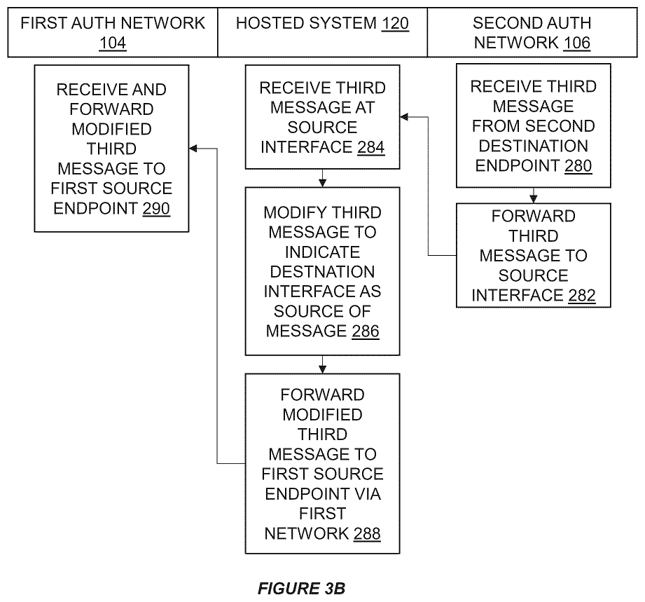

The system (100) described above may implement a method for routing digital messages via authentication networks. Exemplary methods for routing digital messages via authentication networks are illustrated in the swim-lane flow diagrams of FIGS. 2 and 3 in which respective swim-lanes delineate steps, operations or procedures performed by respective entities or devices.

FIGS. 2A and 2B are swim-lane flow diagrams which illustrate a method for updating a set of routing information between two networks via the hosted system (120). Respective swim lanes may indicate or delineate steps or operations performed by respective devices. The hosted system (120) may transmit (202) a set update request to a second authentication network (106). The set update request may prompt the second authentication network (106) to provide an updated list of all identifiers and optionally addresses in its directory server routing data structure. The second authentication network (106) may receive (204) the set update request. The second authentication network (106) may transmit (206) a set update response to the hosted system (120). The set update response may include a subset or aggregation of the set of routing information on the second authentication network (106). The subset or aggregation of the set routing information may include destination endpoint identifiers associated with destination endpoints with which the second authentication network is configured to interact (or which are enrolled with the second authentication network). The set update response may further include an address of a directory server of the second authentication network. The hosted system (120) may receive (208) the set update response from the second authentication network. The hosted system (120) may update (210) a hosted system routing data structure to include the destination endpoint identifiers associated with destination endpoints with which the second authentication network is configured to interact and the directory server address for the directory server of the second authentication network.

The first network (104) may transmit (212) a set update request to the hosted system (120). The update request may prompt the hosted system (120) to send an updated list of routing information on the hosted system (120). The hosted system (120) may receive (214) the set update request from the first authentication network. The hosted system (120) may transmit (216) a set update response to the first authentication network (104). The set update response may include an updated list of routing information. The updated list of routing information may include the destination endpoint identifiers associated with destination endpoints with which the second authentication network is configured to interact and a destination interface address of a destination interface of the hosted system. The first authentication network (104) may receive (218) the set update response from the hosted system. The first authentication network (104) may update (220) a routing data structure (such as a directory server routing data structure (114)) to include: the destination endpoint identifiers associated with destination endpoints with which the second authentication network (and any other supported authentication networks) is configured to interact; and, the destination interface address of a destination interface of the hosted system. This may for example include updating the routing data structure to include a second set of routing information including a mapping of the destination endpoint identifier associated with a second destination endpoint and the destination interface address of the destination interface of the hosted system.

A first source endpoint (102.1) may transmit (232) a set update request to the first authentication network (104). The first authentication network (104) may receive (234) the set update request from the first source endpoint. The update request may prompt the first authentication network (104) to send an updated list of the set of routing information on the first authentication network (104). The first authentication network (104) may transmit (236) the set update response to the first source endpoint (102.1). The set update response may include updated routing information. The updated routing information may include the destination endpoint identifiers associated with destination endpoints with which the first authentication network is configured to interact, as well as the destination endpoint identifiers that the first authentication network received from the hosted system. The updated routing information may include a directory server address by way of which a directory server of the first authentication network is addressable. The first source endpoint (102.1) may receive (238) the set update response from the first authentication network. The first source endpoint (102.1) may store (240) the set update response locally in a local endpoint routing data structure (116).

In some examples, the update requests and responses described above are configured in accordance with a security protocol. The update requests and responses may be routine messages as required by the security protocol. For example, the update requests and responses may be preparation request (PReq) and preparation response (PRes) messages used in the 3DS security protocol.

The method described above may repeat periodically, for example hourly, daily or the like. Initiation of the method may be time or event based, or both. In this manner, entity identifiers supported by a second authentication network (106) may be provided to a first source endpoint (102.1) which has configuration to communicate on (or is enrolled with) a first authentication network (104) such that the first source endpoint (102.1) can transmit messages to a second destination endpoint (102.6) which has configuration to communicate on (or is enrolled with) the second authentication network (106). This may be without changing any configuration at the first source endpoint and instead uses routine set update messages that would anyway be transmitted between the first source endpoint and the first authentication network. In other words, the first source endpoint is not required to enroll with (e.g. generate and store keypairs specifically for) the second authentication network in order to be able to transmit messages to the second destination endpoint (102.6).

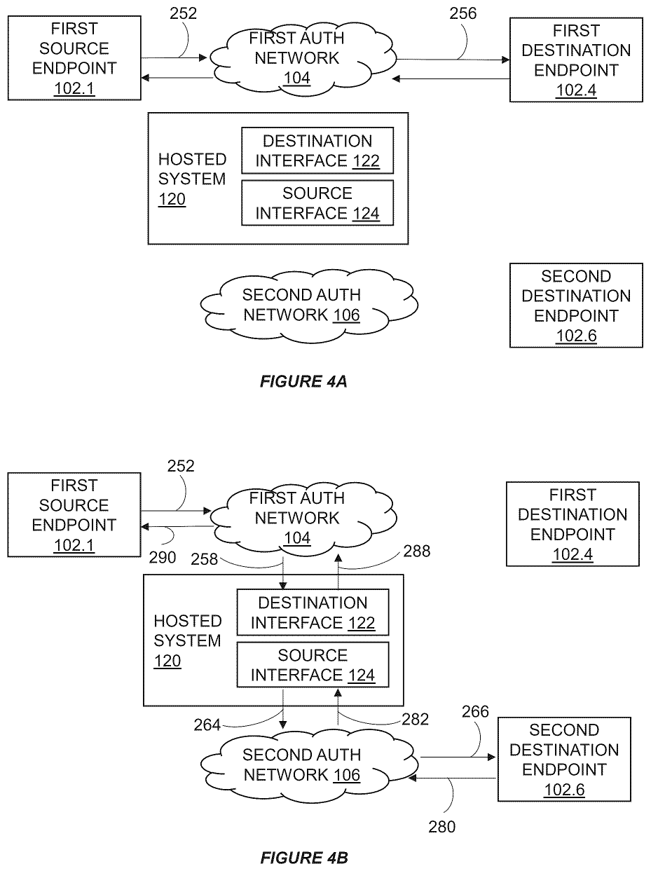

FIGS. 3A and 3B are swim-lane flow diagrams which illustrate an example method for routing digital messages via authentication networks according to aspects of the present disclosure. Respective swim lanes may indicate or delineate steps or operations performed by respective devices. The method is described in conjunction with FIGS. 4A and 4B.

The first authentication network (104) may receive (252) a message from a first source endpoint (102.1). The message may include an entity identifier or destination endpoint identifier which determines a destination endpoint to which the message is to be routed. The message may include a source indicator which indicates the first source endpoint as the source of the message. The source indicator may for example be a “source,” “from,” “origin” or equivalent field and may include a first source endpoint address. The first authentication network (104) may check (254) if the destination endpoint identifier is included in a first or a second set of routing information. The first authentication network may for example query a routing information data structure (such as a directory server routing information data structure) to retrieve an address of an endpoint to which the message should be routed. If the message includes a destination endpoint identifier associated with (or mapped to) a first destination endpoint address, the method includes routing (256) the message to the first destination endpoint (102.4) using the first destination endpoint address. Such a message may be termed a first message. Otherwise, if the message includes a destination endpoint identifier associated with a destination interface address pointing to a destination interface of a hosted system, the method may include routing (258) the message to the destination interface (122) of the hosted system using the destination interface address. Such a message may be termed a second message (even though it may differ from the first message only in that the destination endpoint identifier included therein points to the destination interface of the hosted system). That is, “first message” and “second message” are used simply to differentiate between two alternative scenarios which may arise in accordance with aspects of the present disclosure.

The hosted system (120) may receive (260) the second message at the destination interface (122) from the first authentication network. The hosted system (120) may modify the second message to indicate a source interface (124) of the hosted system as the source of the second message. This may for example include modifying the source indicator of the message to indicate the source interface of the hosted system, and not the first source endpoint, as the source of the message. Modifying the message may include extracting and temporarily storing a first source endpoint address in a source/destination mapping maintained by the hosted system. Modifying the message may include recording the source interface address in the source field of the message. The hosted system (120) may forward (264) the modified second message to the second authentication network (106) for onforwarding to a second destination endpoint (102.6). When forwarding the modified second message, the source interface of the hosted system may authenticate with the second authentication network and/or a second directory server thereof. Forwarding the modified second message may include authenticating the source interface of the hosted system with the second directory server. The second directory server may be a directory server of the second authentication network. The second authentication network (106) may receive and forward (266) the modified second message to the second destination endpoint (102.6).

At some stage, e.g., in response to an action performed after the second destination endpoint receives the modified second message, the second authentication network (106) may receive (280) a third message from the second destination endpoint (102.6). The third message may include the source interface address and/or the second destination endpoint identifier. The third message may further include a source indicator which indicates the second destination endpoint (102.6) as the source of the message. The source indicator may for example be a “source,” “from,” “origin” or equivalent field of the message and may include a second destination endpoint address. The message may further include a “to” field which may include the source interface address therein. The second authentication network (106) may forward (282) the third message to the source interface (124) at the hosted system (120) (e.g. using the source interface address included therein). The hosted system (120) may receive (284) the third message at the source interface (124) from the second authentication network. The hosted system (120) may modify (286) the third message to indicate the destination interface (122) as the source of the third message. This may for example include modifying the source indicator of the message to indicate the destination interface of the hosted system, and not the second destination endpoint, as the source of the message. Modifying the message may include extracting and temporarily storing a second destination endpoint address in a source/destination mapping maintained by the hosted system (e.g., associating it with a first source endpoint address stored therein). Modifying the message may include recording the destination interface address in the source field of the message. In some examples the method may further include modifying a “to” field of the message to include the first source endpoint address (e.g. by replacing the source interface address with the first source endpoint address using the source/destination mapping). The hosted system (120) may forward (288) the modified third message to the first authentication network (104) for onforwarding to the first source endpoint (102.1). The first authentication network (104) may receive and forward (290) the modified third message to the first source endpoint (102.1).

Although not described above, a fourth message in response to the first message may be sent from the first destination endpoint to the first authentication network for onforwarding to the first source endpoint. The messages exchanged in the method described above with reference to FIGS. 3A and 3B may be request and response messages of a security protocol. For example, the first and second messages may be authentication request (AReq) messages and the third and fourth messages may be authentication response (ARes) messages used in the 3DS security protocol. The method of FIGS. 3A and 3B may similarly be extended, mutatis mutandis, to results request (RReq) and results response (RRes), challenge request (CReq) and challenge response (CRes) messages and the like.

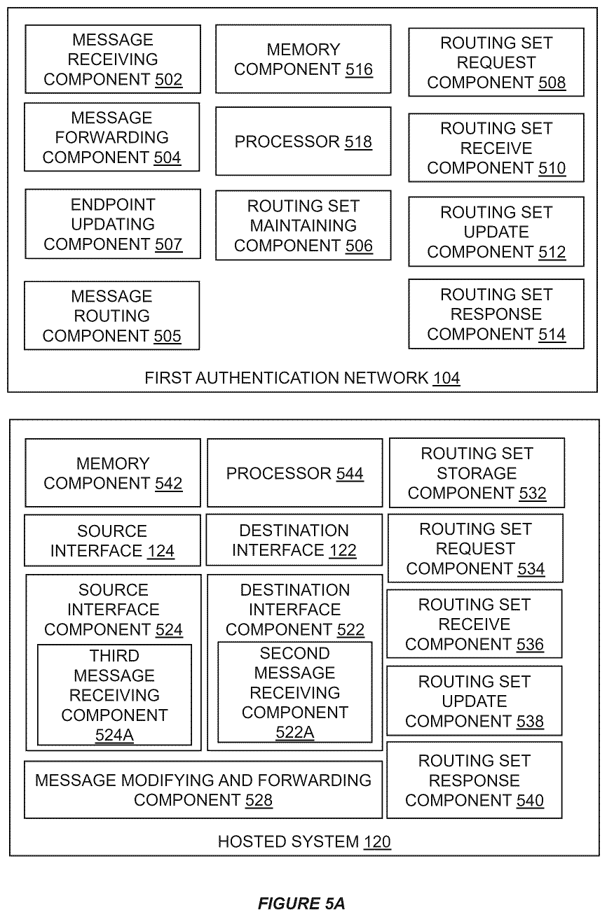

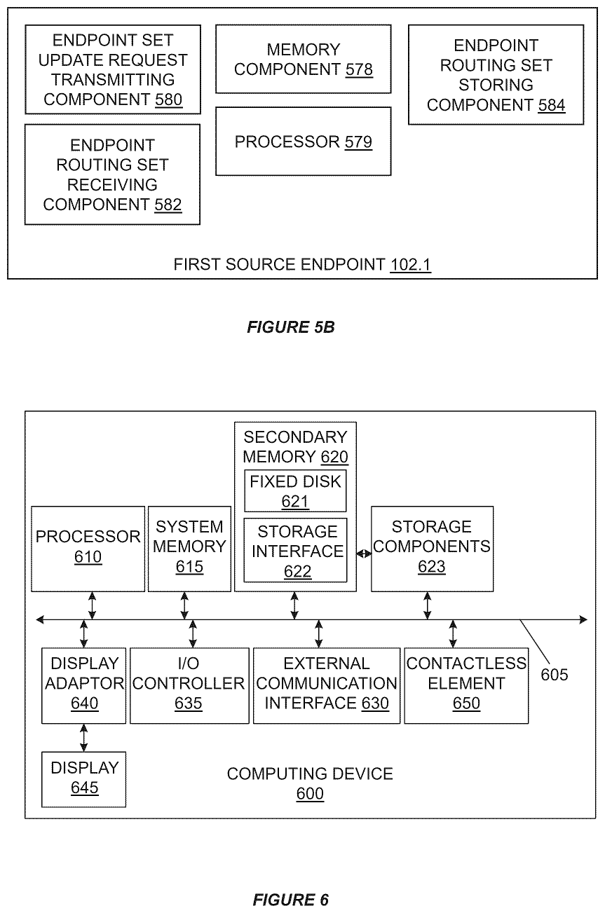

Various components may be provided for implementing the methods described above with reference to FIGS. 2 and 3. FIG. 5A is a block diagram which illustrates exemplary components which may be provided by a system for routing digital messages via authentication networks according to aspects of the present disclosure. The system includes a first authentication network (104) and a hosted system (120).

The first authentication network (104) may include a processor (518) for executing the functions of components described below, which may be provided by hardware or by software units executing on the first authentication network (104). The software units may be stored in a memory component (516) and instructions may be provided to the processor (518) to carry out the functionality of the described components.

The first authentication network (104) may include one or both of: a message receiving component (502) and a message forwarding component (504) arranged to receive and forward, respectively, messages to and from endpoints or to and from a hosted system (120). The first authentication network (104) may include a routing set request component (508) arranged to transmit a routing set update request to the hosted system (120). The first authentication network (104) may include a routing set receive component (510) arranged to receive a routing set response from a hosted system (120). The first authentication network (104) may include a routing set response component (514) arranged to respond to a routing set update request from any one of: an endpoint (102.1 to 102.7), or a hosted system (120). The first authentication network (104) may include a routing set update component (512) arranged to update a routing data structure to include a second set of routing information. The first authentication network (104) may include a routing set maintaining component (506) arranged to update and/or maintain a routing data structure which includes a first set of routing information mapping a first destination endpoint identifier to a first destination endpoint and a second set of routing information mapping a second destination endpoint identifier to a destination interface of a hosted system. The routing set maintaining component (506) may be configured to update the routing data structure in response to receiving an updated routing set. The first authentication network (104) may include an endpoint updating component (507) arranged to update a first source endpoint with configuration to transmit messages associated with the first destination endpoint identifier and messages associated with the second destination endpoint identifier to the first directory server. The authentication network may include a message routing component (505) arranged to route a first message associated with the first destination endpoint identifier to a destination endpoint in response to receiving, from the first source endpoint, a first message associated with the first destination endpoint identifier. The message routing component (505) may be configured to route a second message to a destination interface of the hosted system in response to receiving, from the first source endpoint, a second message associated with the second destination endpoint identifier.

The hosted system (120) may include a processor (544) for executing the functions of components described below, which may be provided by hardware or by software units executing on the hosted system (120). The software units may be stored in a memory component (542) and instructions may be provided to the processor (544) to carry out the functionality of the described components.

The hosted system may include a destination interface (122) and a source interface (124). The hosted system (120) may include a destination interface component (522) arranged to enable the destination interface (122) to receive or forward a message. The hosted system (120) may include a source interface component (524) arranged to enable the source interface (124) to forward or receive a message. The hosted system (120) may include a second message receiving (522A) component arranged to receive, at the destination interface of the hosted system, a second message from a first source endpoint via a first directory server. The hosted system (120) may include a third message receiving component (524A) arranged to receive, at the source interface of the hosted system, a third message being a response to the second message having been transmitted from the second destination endpoint via the second directory server.

The hosted system (120) may include a message modifying and forwarding component (528) arranged to modify a message to appear as if it originates from either one of: the destination interface (122) or the source interface (124) before forwarding the message.

The message modifying and forwarding component may be configured to modify the second message to indicate a source interface of the hosted system as the source of the message and forward the modified second message to a second directory server associated with the second destination endpoint. The message modifying and forwarding component may be further configured to modify the third message to indicate the destination interface of the hosted system as the source of the message and forward the modified third message to the first source endpoint via the first directory server.

The hosted system (120) may include a routing set request component (534) arranged to transmit a routing set update request to an authentication network. The hosted system (120) may include a routing set receiving component (536) arranged to receive a routing set response from an authentication network. The hosted system (120) may include a routing set response component (540) arranged to respond to a routing set update request from any one or both of: an authentication network, and an endpoint (102.1 to 102.7). The hosted system (120) may include a routing set update component (538) arranged to update routing information to include a second set of routing information. The hosted system (120) may include a routing set storing component (532) arranged to store a routing data structure in response to receiving an updated routing set.

FIG. 5B is a block diagram which illustrates components which may be provided by a source endpoint, such as a first source endpoint (102.1), according to aspects of the present disclosure. The first source endpoint (102.1) may include a processor (579) for executing the functions of components described below, which may be provided by hardware or by software units executing on the first source endpoint (102.1). The software units may be stored in a memory component (578) and instructions may be provided to the processor (579) to carry out the functionality of the described components.

The first source endpoint may include an endpoint set update request transmitting component (580) arranged to transmit a set update request to an authentication network. The set update request may prompt the authentication network to send an updated list of routing information to the source endpoint. The first source endpoint may include an endpoint routing set receiving component (582) arranged to receive a response from the authentication network. The response may include an updated list of routing information. The updated list of routing information may include the endpoint routing data structure (112) stored on the directory server (110). The first source endpoint may include an endpoint routing set storing component (584) arranged to store the updated list of routing information locally at the first source endpoint. The updated list may be stored in the local endpoint routing data structure (116).

Systems and methods for routing digital messages via authentication networks are therefore provided. Aspects of the present disclosure provide a platform that connects 3DS components, delivering functionality that complies w/PCI-DSS. Registration may only consist of other Directory Servers (i.e., no ACS or 3DSS/MPIs. Participating networks may be required to register the hosted system in their own DS.) Platform administration may be controlled by a master network. AReq/ARes, RReq/RRes and PReq/PRes messages may be exchanged. Regarding PKI/Certificates, all connections to the hosted system may use the master client's Certificate Authority (CA) certs. Other interactions may use existing certificates (including all roots) used by participating networks. The hosted system may provide a configurable parameter for time-outs (configurable per participating network). Regarding administration and reporting (for the master client), each participating network may be assigned an individual port on the hosted system and the structure may adopt DS multi-tenancy. Aspects of the present disclosure may: enable EMV 3DS 2.x transactions initiated at one network's Directory Server to be routed to a different network's Directory Server; provide ability to support 2-n connections to other Directory Servers; require minimal to zero changes required to existing ACS and 3DSS endpoints.

In some examples, a first authentication network may: receive, by a directory server of a closed electronic commerce card authentication system, an authentication request message for a credit card transaction from a merchant system of the electronic commerce card authentication system; and, send, by the directory server, the authentication request message to a hosted system with an interoperability functionality for authentication of credit card transaction of different electronic commerce card authentication systems, if card range information of the authentication request fails to match card range data of the electronic commerce card authentication system, or if the indicated card range of the transaction data matches to card range data of the interoperability system. In some examples, a hosted system may send, by an interoperability function for authentication of credit card transaction of different closed electronic commerce card authentication systems, to a first directory server of a first closed electronic commerce card authentication system, information indicating the interoperability system an access control server for credit card transactions concerning at least one card range; and, receive, at the interoperability function from the first directory server of the first electronic commerce card authentication system, an authentication request for a credit card transaction concerning at least one credit card of said at least one card range; modify, at the interoperability function, the received authentication request to indicate the interoperability function as a merchant authentication system of the received authentication request; and, send, by the interoperability function, the modified authentication request to a directory server of a second electronic commerce card authentication system. The hosted system may, in response to receiving an authentication response from the second electronic commerce card authentication system, modify the received authentication response to indicate the interoperability function as the access control server of the received authentication response; and, send the modified received authentication response to the first directory server of the first electronic commerce card authentication system.

FIG. 6 illustrates an example of a computing device (600) in which various aspects of the disclosure may be implemented. The computing device (600) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (600) may be suitable for storing and executing computer program code. The various participants and elements in the previously described system diagrams may use any suitable number of subsystems or components of the computing device (600) to facilitate the functions described herein. The computing device (600) may include subsystems or components interconnected via a communication infrastructure (605) (for example, a communications bus, a network, etc.). The computing device (600) may include one or more processors (610) and at least one memory component in the form of computer-readable media. The one or more processors (610) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (600) may be distributed over a number of physical locations (e.g. in a distributed, cluster or cloud-based computing configuration) and appropriate software units may be arranged to manage and/or process data on behalf of remote devices.

The memory components may include system memory (615), which may include read only memory (ROM) and random-access memory (RAM). A basic input/output system (BIOS) may be stored in ROM. System software may be stored in the system memory (615) including operating system software. The memory components may also include secondary memory (620). The secondary memory (620) may include a fixed disk (621), such as a hard disk drive, and, optionally, one or more storage interfaces (622) for interfacing with storage components (623), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (600) may include an external communications interface (630) for operation of the computing device (600) in a networked environment enabling transfer of data between multiple computing devices (600) and/or the Internet. Data transferred via the external communications interface (630) may be in the form of signals, which may be electronic, electromagnetic, optical, radio, or other types of signals. The external communications interface (630) may enable communication of data between the computing device (600) and other computing devices including servers and external storage facilities. Web services may be accessible by and/or from the computing device (600) via the communications interface (630).

The external communications interface (630) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (610). A computer program product may be provided by a non-transient or non-transitory computer-readable medium, or may be provided via a signal or other transient or transitory means via the communications interface (630).

Interconnection via the communication infrastructure (605) allows the one or more processors (610) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (600) either directly or via an I/O controller (635). One or more displays (645) (which may be touch-sensitive displays) may be coupled to or integrally formed with the computing device (600) via a display or video adapter (640).

The foregoing description has been presented for the purpose of illustration; it is not intended to be exhaustive or to limit the embodiments to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

What is claimed is:

1. A computer-implemented method conducted at a first directory server comprising:
maintaining a routing data structure which includes a first set of routing information mapping a first destination endpoint identifier to a first destination endpoint and a second set of routing information mapping a second destination endpoint identifier to a destination interface of a hosted system;
updating a first source endpoint with configuration to transmit messages associated with the first destination endpoint identifier and messages associated with the second destination endpoint identifier to the first directory server;
in response to receiving, from the first source endpoint, a first message associated with the first destination endpoint identifier, routing the first message to the first destination endpoint; and,
in response to receiving, from the first source endpoint, a second message associated with the second destination endpoint identifier, routing the second message to the destination interface of the hosted system.

2. The computer-implemented method of claim 1, wherein updating the first source endpoint with configuration forms part of a routine update process, and wherein the routine update process is part of a preparation process of a security protocol.

3. The computer-implemented method of claim 1, wherein maintaining the routing data structure includes maintaining a directory server routing data structure and an endpoint routing data structure, wherein the directory server routing data structure includes the first set of routing information and the second set of routing information, and wherein the endpoint routing data structure includes a mapping of the first destination endpoint identifier and the second destination endpoint identifier to the first directory server.

4. The computer-implemented method of claim 1, wherein the first set of routing information includes the first destination endpoint identifier and a first destination endpoint address, and wherein the second set of routing information includes the second destination endpoint identifier and a destination interface address which points to the destination interface of the hosted system.

5. The computer-implemented method of claim 1, including, during an initialisation stage:
receiving the second set of routing information from the hosted system;
updating the routing data structure to include the second set of routing information in addition to the first set of routing information; and,
updating the first source endpoint with configuration to transmit messages associated with the second destination endpoint identifier to the first directory server in addition to transmitting messages associated with the first destination endpoint identifier to the first directory server.

6. The computer-implemented method of claim 1, including, in response to receiving, from the hosted system, a third message being a response to the second message and indicating the destination interface of the hosted system as a source of the message, routing the third message to the first source endpoint.

7. The computer-implemented method of claim 6, wherein the first and second messages are authentication request (AReq) messages of a security protocol, and wherein the third message is an authentication response (ARes) message of the security protocol.

8. The computer-implemented method of claim 7, wherein receiving the second set of routing information from the hosted system includes receiving the second set of routing information in a preparation response message (PRes) of the security protocol.

9. A computer-implemented method conducted at a hosted system, the method comprising:
receiving, at a destination interface of the hosted system, a second message from a first source endpoint via a first directory server;
modifying the second message to indicate a source interface of the hosted system as a source of the message and forwarding the modified second message to a second directory server associated with the second destination endpoint;
receiving, at the source interface of the hosted system, a third message being a response to the second message having been transmitted from the second destination endpoint via the second directory server; and,
modifying the third message to indicate the destination interface of the hosted system as the source of the message and forwarding the modified third message to the first source endpoint via the first directory server.

10. The computer-implemented method of claim 9, including transmitting a second set of routing information to the first directory server for updating a routing data structure to include the second set of routing information, wherein the second set of routing information is associated with the second destination endpoint and the destination interface of the hosted system.

11. The computer-implemented method of claim 9, wherein modifying the second message to indicate the source interface of the hosted system as the source of the message includes updating a source field of the message to replace an identifier of the first source endpoint with an identifier of the source interface of the hosted system.

12. The computer-implemented method of claim 11, the identifier of the first source endpoint and source interface are addresses.

13. The computer-implemented method of claim 9, wherein forwarding the modified second message to the second directory server associated with the second destination endpoint includes forwarding the modified second message from the source interface of the hosted system.

14. The computer-implemented method of claim 13, wherein forwarding the modified second message from the source interface of the hosted system includes authenticating the source interface of the hosted system with the second directory server.

15. The computer-implemented method of claim 9, wherein modifying the third message to indicate the destination interface of the hosted system as the source of the message includes updating a source field of the message to replace an identifier of the second destination endpoint with an identifier of the destination interface of the hosted system.

16. The computer-implemented method of claim 9, wherein forwarding the modified third message to the first source endpoint via the first directory server includes forwarding the modified third message from the destination interface of the hosted system.

17. The computer-implemented method of claim 16, wherein forwarding the modified third message from the destination interface of the hosted system includes authenticating the destination interface of the hosted system with the first directory server.

18. A system including a first source endpoint comprising: a non-transitory computer-readable storage medium; and one or more processors coupled to the non-transitory computer-readable storage medium, wherein the non-transitory computer-readable storage medium comprises program instructions that, when executed on the one or more processors, cause the first source endpoint to perform operations comprising:
transmitting a set update request to a first directory server, the set update request being a message prompting the first directory server to send an updated list of routing information on a first authentication network;
receiving, from the first directory server, a set update response including the updated list of routing information; and,
storing the updated list of routing information in a local endpoint routing data structure, wherein the updated list includes routing information mapping a first destination endpoint identifier and a second destination endpoint identifier to the first directory server.

19. The system of claim 18 including the first directory server comprising: a non-transitory computer-readable storage medium; and one or more processors coupled to the non-transitory computer-readable storage medium, wherein the non-transitory computer-readable storage medium comprises program instructions that, when executed on the one or more processors, cause the first directory server to perform operations comprising:
maintaining a routing data structure which includes a first set of routing information mapping the first destination endpoint identifier to a first destination endpoint and a second set of routing information mapping the second destination endpoint identifier to a destination interface of a hosted system;
updating the first source endpoint with configuration to transmit messages associated with the first destination endpoint identifier and messages associated with the second destination endpoint identifier to the first directory server;
in response to receiving, from the first source endpoint, a first message associated with the first destination endpoint identifier, routing the first message to the first destination endpoint; and,
in response to receiving, from the first source endpoint, a second message associated with the second destination endpoint identifier, routing the second message to the destination interface of the hosted system.

20. The system of claim 19 including the hosted system comprising: a non-transitory computer-readable storage medium; and one or more processors coupled to the non-transitory computer-readable storage medium, wherein the non-transitory computer-readable storage medium comprises program instructions that, when executed on the one or more processors, cause the hosted system to perform operations comprising:
receiving, at the destination interface of the hosted system, the second message from the first source endpoint via the first directory server;
modifying the second message to indicate a source interface of the hosted system as a source of the message and forwarding the modified second message to a second directory server associated with the second destination endpoint;
receiving, at the source interface of the hosted system, a third message being a response to the second message having been transmitted from the second destination endpoint via the second directory server; and,
modifying the third message to indicate the destination interface of the hosted system as the source of the message and forwarding the modified third message to the first source endpoint via the first directory server.
